(19) United States
(12) Patent Application Publication
(10) Pub. No.: US 2018/0273669 A1
(43) Pub. Date: Sep. 27, 2018

(54) CROSS-COPOLYMER AND METHOD FOR PRODUCING SAME

(71) Applicant: Denka Company Limited, Chuo-ku, Tokyo (JP)

(72) Inventor: Toru Arai, Chuo-ku, Tokyo (JP)

(73) Assignee: Denka Company Limited, Chuo-ku, Tokyo (JP)

(21) Appl. No.: 15/763,428

(22) PCT Filed: Sep. 12, 2016
(86) PCT No.: PCT/JP2016/076819

§ 371 Date: Mar. 26, 2018

(30) Foreign Application Priority Data
Sep. 28, 2015 (JP) 2015-189405

(51) Int. Cl. C08F 297/02

(52) U.S. Cl. CPC C08F 297/02; C08F 2800/20; C08F 2800/10; C08F 2400/00

(57) ABSTRACT

An object of the present invention is to provide a cross-copolymer having excellent softness and heat resistance which is useful as a thermoplastic elastomer, and provide a method for producing thereof.

The present invention provides a method for producing a cross-copolymer comprising a coordination polymerization step and an anionic polymerization step, the cross-copolymer has a specific structure. The present invention also provides a cross-copolymer having excellent moldability, softness and heat resistance, which can be produced under the producing conditions satisfying that the molecular weight distribution of the copolymer obtained in the coordination polymerization step is in a specific range.

### TECHNICAL FIELD

The present invention relates to a cross-copolymer having good moldability and improved softness and heat resistance, and a method for producing the same.

### BACKGROUND ART

A method for producing a copolymer in which an anionic polymerization is carried out in the presence of a macromonomer and an aromatic vinyl compound (styrene) monomer, the macromonomer is an ethylene-aromatic vinyl compound (styrene)-divinylbenzene copolymer macromonomer obtained by a coordination polymerization, and a cross-copolymer obtained by the method are known (PLT1 and PLT2). The cross-copolymer is a branched block copolymer having an ethylene-aromatic vinyl compound (styrene) copolymer block which is a soft segment and an aromatic vinyl compound (styrene) polymer block which is a hard segment. And, the cross-copolymer has higher heat resistance and compatibility compared with a copolymer having only a soft segment. In particular, the cross-copolymer shown in PLT 2 is further softer and has a feature of excellent transparency.

### CITATION LIST

### Patent Literature

PLT1: WO2000/037517

PLT2: WO2007/139116

### SUMMARY OF INVENTION

### Technical Problem

In such cross-copolymer, there is a problem that both softness and heat resistance are compatible while maintaining moldability (MFR), or heat resistance is further improved with the same softness and moldability (MFR).

The present invention has been made in view of the above circumstances, and an object of the present invention is to provide a cross-copolymer having improved heat resistance while having softness and good moldability compared with the prior art, and provide a method for producing such the cross-copolymer.

### Solution to Problem

The present invention relates to a method for producing a cross-copolymer wherein in a coordination polymerization step, an ethylene-aromatic vinyl compound-aromatic polyene copolymer which is a macromonomer is synthesized by copolymerizing an ethylene monomer, an aromatic vinyl compound monomer and an aromatic polyene with a single site coordination polymerization catalyst, in an anionic polymerization step, a polymerization in the presence of the macromonomer and an aromatic vinyl compound monomer is performed. In the method, by setting the structure and proportion of the macromonomer within a specific range, it is possible to satisfy excellent softness, moldability and heat resistance. Further, the method is a method for producing the cross-copolymer, which is characterized by using a specific transition metal compound catalyst and a boron co-catalyst under specific polymerization conditions. Here, the cross-copolymer means a copolymer having an olefin-aromatic vinyl compound-aromatic polyene copolymer chain (sometimes referred to as a main chain) and an aromatic vinyl compound polymer chain (sometimes referred to as a side chain).

### Advantageous Effects of Invention

According to the present invention, it is possible to efficiently produce a cross-copolymer having both excellent softness and heat resistance while having excellent moldability.

### BRIEF DESCRIPTION OF DRAWINGS

FIG. 1 is a graph illustrating changes in storage modulus versus temperature of the copolymers obtained in Example 1 and Comparative Example 1.

### DESCRIPTION OF EMBODIMENTS

### 1. Summary of the Present Invention

An embodiment of the present invention is a method for producing a cross-copolymer comprising a coordination polymerization step and an anionic polymerization step, wherein the coordination polymerization step is followed by the anionic polymerization step, in the coordination polymerization step, an ethylene-aromatic vinyl compound-aromatic polyene copolymer which is a macromonomer is synthesized by copolymerizing an ethylene monomer, an aromatic vinyl compound monomer and an aromatic polyene with a single site coordination polymerization catalyst, in the anionic polymerization step, a polymerization using an anionic polymerization initiator in the presence of the macromonomer and an aromatic vinyl compound monomer is performed. The cross-copolymer satisfies all the following features (1) to (3):

(1) in the ethylene-aromatic vinyl compound-aromatic polyene copolymer macromonomer, the aromatic vinyl compound unit content is 15 mol % or more and 30 mol % or less, the aromatic polyene unit content is 0.01 mol % or more and 0.2 mol % or less, and the rest is the ethylene unit content;

(2) a weight average molecular weight (Mw) of the ethylene-aromatic vinyl compound-aromatic polyene copolymer macromonomer is 100,000 or more and 250,000 or less and a molecular weight distribution (Mw/Mn) is 3.5 or more and 6 or less;

(3) a mass ratio of the ethylene-aromatic vinyl compound-aromatic polyene copolymer macromonomer component in the cross-copolymer obtained through the anionic polymerization step is 60% by mass or more and 95% by mass or less, preferably 65% by mass or more and 90% by mass or less.

An embodiment of the present invention is a cross-copolymer obtained by the above method, wherein the cross-copolymer satisfies all the following features (A) to (E):

(A) a hardness is 50 or more and 85 or less, preferably 50 or more and 80 or less;

(B) a sum of a crystal fusion heat (AH) of the cross-copolymer observed at 0 to 150° C. is 25 J/g or less;

(C) MFR measured at 200° C. under a load of 98 N is 5 g/10 min or more and 40 g/10 min or less;

(D) a gel content of less than 1% by mass, preferably less than 0.1% by mass;

(E) a ratio of a storage modulus at 100° C. to a storage modulus at 20° C. measured with DMA is 0.05 or more and 0.2 or less.

By satisfying all the producing conditions of the cross-copolymer of the above features (1) to (3), it is possible to obtain a cross-copolymer satisfying all the above features (A) to (E).

When the macromonomer does not satisfy the condition that the aromatic vinyl compound unit content of the macromonomer is 15 mol % or more and 30 mol % or less, the softness lowers and it may be difficult to satisfy the feature (A) of hardness.

When the aromatic polyene unit content is higher than the above range, it is possible that MFR value of the cross-copolymer is lower than the value specified in the present application and the moldability may be deteriorated, and the above condition of the gel content may not be satisfied.

When the aromatic polyene unit content is lower than the above range, the mechanical properties as the cross-copolymer may be deteriorated. When the weight average molecular weight (Mw) of the macromonomer is lower than the above-mentioned value, the mechanical properties and the heat resistance are lowered. When the weight average molecular weight is higher than the above-mentioned value, the moldability is lowered, and MFR value may decrease to be less than the specified value. When the molecular weight distribution (Mw/Mn) is smaller than the above-mentioned range, it is difficult to satisfy especially the heat resistance (the ratio of the storage modulus at 100° C. to the storage modulus at 20° C.) defined in the present invention. When the mass ratio of the ethylene-aromatic vinyl compound-aromatic polyene copolymer macromonomer component in the cross-copolymer obtained through the anionic polymerization step is lower than the above-mentioned value, the softness is lost. When the mass ratio is higher than the above value, the mechanical properties as the cross-copolymer may be lowered.

### 2. Explanation of Cross-Copolymer

Hereinafter, the cross-copolymer of the present invention will be described. The cross-copolymer is a copolymer having an ethylene-aromatic vinyl compound-aromatic polyene copolymer chain derived from a macromonomer and an aromatic vinyl compound polymer chain, and has a structure in which the ethylene-aromatic vinyl compound-aromatic polyene copolymer chain and the aromatic vinyl compound polymer chain are bonded via the aromatic polyene unit.

### 2-1. Proof of Structure of Cross-Copolymer by NMR

The structure in which the ethylene-aromatic vinyl compound-aromatic polyene copolymer chain and the aromatic vinyl compound polymer chain are bonded via the aromatic polyene unit can be proved by the following observable phenomenon. Here, an example of a polymer in which a representative ethylene-styrene-divinylbenzene copolymer chain and a polystyrene chain are bonded via a divinylbenzene unit is shown. That is, 1H-NMR (proton NMR) of the ethylene-styrene-divinylbenzene copolymer macromonomer obtained in the coordination polymerization step and 1H-NMR of the cross-copolymer obtained by the anionic polymerization in the presence of the ethylene-styrene-divinylbenzene copolymer macromonomer and the styrene monomer are measured. Both peak intensities of the vinyl group hydrogen (proton) of the divinylbenzene units are compared using an appropriate internal standard peak (an appropriate peak come from an ethylene-styrene-divinylbenzene copolymer). Here, a ratio of the peak intensity (area) of the vinyl group hydrogen (proton) of the divinylbenzene unit of the cross-copolymer to the peak intensity (area) of the divinylbenzene unit of the ethylene-styrene-divinylbenzene copolymer macromonomer is less than 50%, preferably less than 20%. In the anionic polymerization (cross-linking step), the divinylbenzene unit is also copolymerized simultaneously with the polymerization of the styrene monomer, so that the ethylene-styrene-divinylbenzene copolymer chain and the polystyrene chain are bonded via the divinylbenzene unit. Therefore, in the cross-copolymer after the anionic polymerization, the peak intensity of the hydrogen (proton) of the vinyl group of the divinylbenzene unit greatly decreases. Actually, the hydrogen (proton) peak of the vinyl group of the divinylbenzene unit is substantially disappeared in the cross-copolymer after the anionic polymerization. Details are described in a published document “Synthesis of Branched Copolymer Using Olefin Copolymer Containing Divinylbenzene Unit”, Toru Arai, Masaru Hasegawa, Nippon Rubber Industry Association Magazine, p. 382, vol. 82 (2009).

### 2-2. Proof of Structure of Cross-Copolymer by Soxhlet Extraction

From another viewpoint, in the present cross-copolymer, the ethylene-aromatic vinyl compound-aromatic polyene copolymer chain and the aromatic vinyl compound polymer chain are bonded via the aromatic polyene unit (for example, the ethylene- the styrene-divinylbenzene copolymer chain and the polystyrene chain are bonded via a divinylbenzene unit) can be proved by the following observable phenomenon. That is, even after Soxhlet extraction is performed a sufficient number of times using an appropriate solvent for the present cross-copolymer, the contained ethylene-styrene-divinylbenzene copolymer chain and the polystyrene chain cannot be separated. Usually, an ethylene-styrene-divinylbenzene copolymer and polystyrene having the same composition as the ethylene-styrene-divinylbenzene copolymer chain contained in the present cross-copolymer are subjected to Soxhlet extraction with boiling acetone, whereby it can be separated into an ethylene-styrene-divinylbenzene copolymer as an acetone-insoluble part, and a polystyrene as an acetone-soluble part. When the same Soxhlet extraction is carried out on the cross-copolymer of the present invention, a relatively small amount of polystyrene homopolymer contained in the cross-copolymer can be obtained as an acetone-soluble part. However, it is shown by a NMR measurement that both the ethylene-styrene-divinylbenzene copolymer chain and the polystyrene chain are contained in an acetone-insoluble part, which is a most part. These of the ethylene-styrene-divinylbenzene copolymer chain and the polystyrene chain cannot be separated. Details are also described in a published document “Synthesis of Branched Copolymer Using Olefin Copolymer Containing Divinylbenzene Unit”, Toru Arai, Masaru Hasegawa, Nippon Rubber Industry Association Magazine, p. 382, vol. 82 (2009).

### 2-3. Definition of Cross-Copolymer of the Present Invention

From the above, the cross-copolymer of the present invention can be specified as follows. The cross-copolymer comprises an ethylene-aromatic vinyl compound-aromatic polyene copolymer chain and an aromatic vinyl compound polymer chain, wherein the ethylene-aromatic vinyl compound-aromatic polyene copolymer chain and the aromatic vinyl compound polymer chain bonded via the aromatic polyene unit. A relatively small amount of an aromatic vinyl compound (polystyrene) homopolymer may be contained in the present cross-copolymer.

The cross-copolymer preferably satisfies all the following features (1) to (3):

(1) in the ethylene-aromatic vinyl compound-aromatic polyene copolymer macromonomer, the aromatic vinyl compound unit content is 15 mol % or more and 30 mol % or less, the aromatic polyene unit content is 0.01 mol % or more and 0.2 mol % or lesse, and the rest is the ethylene unit content;

(2) a weight average molecular weight (Mw) of the ethylene-aromatic vinyl compound-aromatic polyene copolymer macromonomer is 100,000 or more and 250,000 or less and a molecular weight distribution (Mw/Mn) is 3.5 or more and 6 or less;

(3) a mass ratio of the ethylene-aromatic vinyl compound-aromatic polyene copolymer macromonomer component in the cross-copolymer obtained through the anionic polymerization step is 60% by mass or more and 95% by mass or less, preferably 65% by mass or more and 90% by mass or less.

From another viewpoint, the present cross-copolymer will be explained. The cross-copolymer of the present invention is obtained by a producing method comprising a polymerization step which comprises a coordination polymerization step and an anionic polymerization step. In the coordination polymerization step, an ethylene-aromatic vinyl compound-aromatic polyene copolymer is synthesized by copolymerizing an ethylene monomer, an aromatic vinyl compound monomer and an aromatic polyene with a single site coordination polymerization catalyst. Thereafter, in the anionic polymerization step, an anionic polymerization using an anionic polymerization initiator in the presence of the ethylene-aromatic vinyl compound-aromatic polyene copolymer and an aromatic vinyl compound monomer is performed. As the aromatic vinyl compound monomer used in the anionic polymerization step, an unreacted monomer remaining in the polymerization solution in the coordination polymerization step may be used, or an aromatic vinyl compound monomer may be newly added thereto. Addition of the anionic polymerization initiator to the polymerization solution initiates the anionic polymerization. In this case, in the polymerization solution, the aromatic vinyl compound monomer is overwhelmingly more contained than the aromatic polyene unit of the ethylene-aromatic vinyl compound-aromatic polyene copolymer, and the anionic polymerization is substantially initiated from the aromatic vinyl compound monomer. The polymerization proceeds by polymerizing the aromatic vinyl compound monomer and simultaneously copolymerizing the vinyl group of the aromatic polyene unit of the ethylene-aromatic vinyl compound-aromatic polyene copolymer. Therefore, according to the knowledge of the published literature and a skilled person in the art, it is considered that the resulting cross-copolymer mainly contains a structure in which the aromatic vinyl compound polymer chain (a cross chain) and the ethylene-aromatic vinyl compound-aromatic polyene copolymer (a main chain) are bonded in a graft-through manner (cross-linked).

Accordingly, the cross-copolymer of the present invention can be specified as follows. The cross-copolymer is the cross-copolymer described above, and a graft-through copolymer of an ethylene-aromatic vinyl compound-aromatic polyene copolymer chain and an aromatic vinyl compound polymer chain.

The cross-copolymer of the present invention as specified above further satisfies all the above features (A) to (E).

### 3. Coordination Polymerization Step

### 3-1. Single Site Coordination Polymerization Catalyst

### 3-1-1. Transition Metal Compound

An embodiment of the present invention is the producing method, wherein in the coordination polymerization step, the single site coordination polymerization catalyst which contains a transition metal compound represented by a general formula (1) or (6) is used.

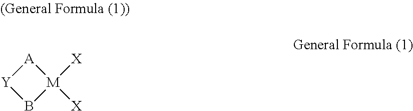

A and B may be the same or different from each other, and each of A and B is a group selected from an unsubstituted or substituted benzoindenyl group, an unsubstituted or substituted cyclopentadienyl group, an unsubstituted or substituted indenyl group, or an unsubstituted or substituted fluorenyl group. The substituted benzoindenyl group, the substituted cyclopentadienyl group, the substituted indenyl group, and the substituted fluorenyl group are respectively a substituted benzoindenyl group, a substituted cyclopentadienyl group, a substituted indenyl group, and a substituted fluorenyl group in which one or more of the substitutable hydrogens are substituted with an alkyl group having 1 to 20 carbon atoms, an aryl group having 6 to 10 carbon atoms, an alkylaryl group having 7 to 20 carbon atoms, a halogen atom, OSiR₃ group, SiR₃ group or PR₂ group (R represents a hydrocarbon group having 1 to 10 carbon atoms).

Preferably, A and B may be the same or different from each other and at least of A and B is a group selected from an unsubstituted or substituted benzoindenyl group represented by general formulas (2), (3), (4), an unsubstituted or substituted indenyl group represented by a general formula (5). Most preferably, A and B may be the same or different from each other and each of A and B is a group selected from an unsubstituted or substituted benzoindenyl group represented by general formulas (2), (3), (4), an unsubstituted or substituted indenyl group represented by a general formula (5).

In the following general formulas (2), (3), and (4), each of R¹ to R³ groups represents hydrogen, an alkyl group having 1 to 20 carbon atoms, an aryl group having 6 to 10 carbon atoms, an alkylaryl group having 7 to 20 carbon atoms, a halogen atom, OSiR₃ group, SiR₃ group or PR₂ group (every R represents a hydrocarbon group having 1 to 10 carbon atoms). R¹ groups may be respectively the same or different from each other, R² groups may be respectively the same or different from each other and R³ groups may be the same or different from each other. Adjacent R¹ groups and adjacent R² groups may together form a 5- to 8-membered aromatic or aliphatic ring.

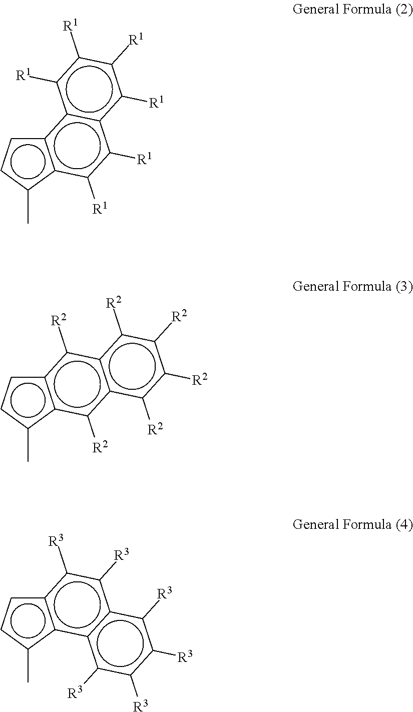

Examples of the unsubstituted benzoindenyl group represented by the above general formulas include 4,5-benzo-1-indenyl group (akyl benzo (e) indenyl group), 5,6-benzo-1-indenyl group, 6,7-benzo-1-indenyl group. Examples of the substituted benzoindenyl group include α-acenaphtho-1-indenyl group, 3-cyclopenta [c] phenanthryl group and 1-cyclopenta [1] phenanthryl group.

In the following general formula (5), each of R⁴ groups represents hydrogen, an alkyl group having 1 to 20 carbon atoms, an aryl group having 6 to 10 carbon atoms, an alkylaryl group having 7 to 20 carbon atoms, a halogen atom, a OSiR₃ group, a SiR₃ group or a PR₂ group (every R represents a hydrocarbon group having 1 to 10 carbon atoms). R⁴ groups may be the same or different from each other.

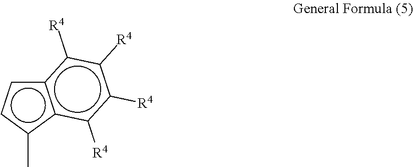

Examples of the unsubstituted indenyl group represented by the above general formula include 1-indenyl group. Examples of the substituted indenyl group include 4-methyl-1-indenyl group, 5-ethyl-1-indenyl group, 4-phenyl-indenyl group, and 4-naphthyl-1-indenyl group.

Further preferably, A and B may be the same or different from each other, and each of A and B is a group selected from an unsubstituted or substituted benzoindenyl group represented by general formulas (2), (3), and (4), an unsubstituted or substituted indenyl group represented by a general formula (5).

Y has a bond with A and B, and may have, as a substituent, hydrogen, a methylene group, a silylene group, an ethylene group, a germylene group or a boron group, each of the methylene group, the silylene group, the ethylene group, the germylene group, and the boron group may have a hydrocarbon group having 1 to 15 carbon atoms (and may further have 1 to 3 of a nitrogen atom, an oxygen atom, a sulfur atom, a phosphorus atom, or a silicon atom). The substituents of Y may be same different from each other. Y may have a cyclic structure.

Preferably, Y has a bond with A and B, and Y may have, as a substituent, a hydrogen, a methylene group or a boron group, each of the methylene group, the silylene group, the ethylene group, the germylene group, and the boron group may have a hydrocarbon group having 1 to 15 carbon atoms (and may further have 1 to 3 of a nitrogen atom, an oxygen atom, a sulfur atom, a phosphorus atom, or a silicon atom).

X is hydrogen, a hydroxyl group, a halogen, a hydrocarbon group having 1 to 20 carbon atoms, an alkoxy group having 1 to 20 carbon atoms, a silyl group having a hydrocarbon substituent having 1 to 4 carbon atoms, or an amide group having a hydrocarbon substituent having 1 to 20 carbon atoms. Two of X may have a bond therebetween.

M is zirconium, hafnium, or titanium.

Further, the transition metal compound is preferably racemic. Preferable examples of the transition metal compound include a transition metal compound having a substituted methylene crosslinked structure specifically exemplified in EP-0872492A2, JPH11-130808 and JPH09 309925, and a transition metal compound having a boron crosslinked structure specifically exemplified in WO01/068719.

### (General Formula (6))

A transition metal compound represented by the following general formula (6) can also be preferably used.

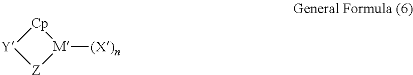

Cp is a group selected from an unsubstituted or substituted cyclopentaphenanthryl group, an unsubstituted or substituted benzoindenyl group, an unsubstituted or substituted cyclopentadienyl group, an unsubstituted or substituted indenyl group, or an unsubstituted or substituted fluorenyl group. The substituted cyclopentaphenanthryl group, the substituted benzoindenyl group, the substituted cyclopentadienyl group, the substituted indenyl group, and the substituted fluorenyl group are respectively a substituted benzoindenyl group, a substituted cyclopentadienyl group, a substituted indenyl group, or a substituted fluorenyl group in which one or more of the substitutable hydrogens is substituted with an alkyl group having 1 to 20 carbon atoms, an aryl group having 6 to 10 carbon atoms, an alkylaryl group having 7 to 20 carbon atoms, a halogen atom, a OSiR₃ group, a SiR₃ group or a PR₂ group (R represents a hydrocarbon group having 1 to 10 carbon atoms).

Y′ has a bond with Cp and Z, and Y′ may have, as a substituent, hydrogen, or a methylene group, a silylene group, an ethylene group, a germylene group or a boron group, each of the methylene group, the silylene group, the ethylene group, the germylene group, and the boron group may have a hydrocarbon group having 1 to 15 carbon atoms. The substituents of Y′ may be same different from each other. Y′ may have a cyclic structure.

Z has a nitrogen atom, an oxygen atom or a sulfur atom, is a ligand coordinating to M′ by the nitrogen atom, the oxygen atom or the sulfur atom, Z has a bond with Y′, and Z further has hydrogen or a group atom having a substituent having 1 to 15 carbon atoms.

M′ is zirconium, hafnium, or titanium.

X′ is hydrogen, halogen, an alkyl group having 1 to 15 carbon atoms, an aryl group having 6 to 10 carbon atoms, an alkylaryl group having 8 to 12 carbon atoms, a silyl group having a hydrocarbon substituent having 1 to 4 carbon atoms, an alkoxy group having 1 to 10 carbon atoms, or a dialkylamide group having an alkyl substituent having 1 to 6 carbon atoms.

n is an integer of 1 or 2.

Transition metal compounds represented by the general formula (6) are described in WO99/14221, EP416815 and U.S. Pat. No. 6,254,956.

### 3-1-2. Co-Catalyst

In the coordination polymerization step of the present producing method, a single site coordination polymerization catalyst comprising a transition metal compound represented by the above general formula (1) and a co-catalyst is preferably used. When a single site coordination polymerization catalyst composed of the transition metal compound represented by the above general formula (1) and the co-catalyst is used, in particular, copolymerizability for aromatic vinyl compounds and aromatic polyenes is high. Therefore, such single site coordination polymerization catalyst is preferred to efficiently copolymerize and to have high activity.

As the co-catalyst used in the coordination polymerization step of the present producing method, a known co-catalyst conventionally used in combination with a transition metal compound may be used. As such the promoter, alumoxane (or methylalumoxane or MAO) such as methylaluminoxane or a boron compound (boron co-catalyst) is preferably used. If necessary, an alkylaluminum such as triisobutylaluminum or triethylaluminum may be used together with the alumoxane and the boron compound (boron co-catalyst). Examples of such co-catalyst include co-catalysts and alkyl aluminum compounds described in EP-0872492A2, JPH11-130808, JPH09-309925, WO00/20426, EP0985689A2 and JPH06-184179.

A co-catalyst such as alumoxane may be used in a specific ratio to the transition metal compound metal and the ratio of aluminum atom/transition metal atom is 0.1 to 100000, preferably 10 to 10000. When the ratio is less than 0.1, it is not possible to effectively activate the transition metal compound, and when the ratio exceeds 100000, it is economically disadvantageous.

In the present invention, the boron co-catalyst used in the coordination polymerization step of the present producing method is preferably a boron co-catalyst which has been conventionally used in combination with a transition metal compound. Using the boron co-catalyst gives an advantage that the cross-copolymer with large molecular weight distribution satisfying the condition of the feature (2) (which is a weight average molecular weight (Mw) of the ethylene-aromatic vinyl compound-aromatic polyene copolymer is 100,000 or more and 250,000 or less and a molecular weight distribution (Mw/Mn) is 3.5 or more and 6 or less) is easily obtained. On the other hand, when alumoxane such as methyl aluminoxane is used as a co-catalyst, the molecular weight distribution becomes particularly less than 3.5, so that it is required to increase the molecular weight distribution by a complicated method such as greatly changing polymerization conditions such as polymerization temperature during the coordination polymerization, multistage polymerization with different polymerization conditions or adding a chain transfer agent during the polymerization. Such the boron co-catalyst suitable for the present invention is described in, for example, JPH03-207703, JPH05-194641, JPH08-034809, JPH08-034810, H. H. Brintzinger, D. Fischer, R. Muelhaupt, R. Rieger, R. Waymouth, Angew. Chem. 1995, 107, 1255-1283, EP558158, U.S. Pat. No. 5,348,299, EP426637.

Examples of the boron co-catalyst include trispentafluorophenylborane, triphenylcarbenium tetrakis (pentafluorophenyl) borate {trityl tetrakis (pentafluorophenyl) borate}, lithium tetrakis (pentafluorophenyl) borate, trimethyl ammonium tetraphenyl borate, triethylammonium tetraphenylborate, tripropylammonium tetraphenylborate, tri (n-butyl) ammonium tetraphenylborate, tri (n-butyl) ammonium tetra (p-tolyl) phenyl borate, tri (n-butyl) ammonium tetra (p-ethylphenyl) borate, tri (n-butyl) ammonium tetra (pentafluorophenyl) borate, trimethylammoniumtetra (p-tolyl) borate, trimethylammonium tetrakis-3,5-dimethylphenyl borate, triethylammonium tetrakis-3,5-dimethylphenyl borate, tributylammonium tetrakis-3,5-dimethylphenyl borate, tributylammonium tetrakis-2,4-dimethylphenyl borate, anilinium tetrakis pentafluorophenyl borate, N, N′-dimethylanilinium tetraphenylborate, N, N′-dimethylanilinium tetrakis (p-tolyl) borate, N, N′-dimethylanilinium tetrakis (m-tolyl) borate, N, N′-dimethylanilinium tetrakis (2,4-dimethylphenyl) borate, N, N′-dimethylanilinium tetrakis (3,5-dimethylphenyl) borate, N, N′-dimethylanilinium tetrakis (pentafluorophenyl) borate, N, N′-diethylanilinium tetrakis (pentafluorophenyl) borate, N, N′-2,4,5-pentamethylanilinium tetraphenylborate, N, N′-2,4,5-pentaethylanilinium tetraphenylborate, di-(isopropyl) ammonium tetrakispentafluorophenyl borate, di-cyclohexylammonium tetraphenylborate, triphenylphosphonium tetraphenylborate, tri (methylphenyl) phosphonium tetraphenylborate, tri (dimethylphenyl) phosphonium tetraphenylborate, triphenylcarbenium tetrakis (p-tolyl) borate, triphenylcarbenium tetrakis (m-tolyl) borate, triphenylcarbenium tetrakis (2,4-dimethylphenyl) borate, triphenylcarbenium tetrakis (3,5-dimethylphenyl) borate, tropylium tetrakis pentafluorophenyl borate, tropylium tetrakis (p-tolyl) borate, tropylium tetrakis (m-tolyl) borate, tropylium tetrakis (2,4-dimethylphenyl) borate, tropylium tetrakis (3,5-dimethylphenyl) borate. The most preferable boron co-catalyst among these is a boron co-catalyst having boron and a fluorine-substituted aromatic group bonded thereto. Examples of such the boron co-catalyst include trispentafluorophenylborane, triphenylcarbenium tetrakis (pentafluorophenyl) borate {trityl tetrakis (pentafluorophenyl) borate}, lithium tetrakis (pentafluorophenyl) borate, tri (n-butyl) ammonium tetra (pentafluorophenyl) borate, tropylium tetrakis pentafluorophenyl borate, N, N-dimethylanilinium tetrakis (pentafluorophenyl) borate. Although the fluorine-substituted aromatic groups having a phenyl group are exemplified above, the fluorine-substituted aromatic groups having a condensed aromatic group such as a fluorine-substituted naphthyl group may be also preferably used. It is further preferred that the boron co-catalyst is a borate co-catalyst, since it gives higher activity. Here, the borate co-catalyst is a boron co-catalyst containing an anion having boron (borate), and a counter cation.

In using these boron co-catalysts, known organoaluminum compounds may be used at the same time. In particular, when a boron co-catalyst is used, the addition of an organoaluminum compound is effective for removing impurities which has a bad effect for the polymerization, such as water contained in the polymerization system. Examples of such organoaluminum compounds include triisobutylaluminum, triethylaluminum, trimethylaluminum, trioctylaluminum. The amount of these organoaluminums to the boron co-catalyst is generally in the range of 1 to 1000, preferably 1 to 100, in a molar ratio of aluminum to boron.

When a boron compound is used as a co-catalyst, the co-catalyst may be used in a ratio of boron atom/transition metal atom of 0.01 to 100, preferably 0.1 to 10, particularly preferably 1. When the ratio is less than 0.01, it is not possible to effectively activate the transition metal compound, and when the ratio exceeds 100, it is economically disadvantageous. The transition metal compound and the co-catalyst may be mixed and prepared outside of the polymerization equipment or may be mixed inside of the equipment during the polymerization.

Details of the present cross-copolymer and its producing method are described in WO 2000/37517, or WO2007/139116, the entire disclosure of which is hereby incorporated by reference.

### 3-2. Monomer

Examples of the aromatic vinyl compound monomer in the present invention include styrene and various substituted styrenes such as p-methylstyrene, m-methylstyrene, o-methylstyrene, o-t-butylstyrene, m-t-butylstyrene, p-t-butylstyrene, p-chloro styrene, o-chlorostyrene. From the industrial viewpoint, styrene, p-methylstyrene, p-chlorostyrenend are preferably used, styrene is particularly preferably used.

The aromatic polyene used in the present invention is a monomer which is capable of coordination polymerization, and has a carbon number of 10 to 30 and a plurality of double bonds (vinyl groups) and one or more aromatic groups. The aromatic polyene is an aromatic polyene in which an anionically polymerizable double bond remains after the coordination polymerization using one of the double bonds (vinyl groups). Preferably, one kind or a mixture of two or more kinds of ortho-divinylbenzene, para-dinylvinylbenzene and meta-divinylbenzene is used.

### 3-3. Polymerization Method

In producing the olefin-aromatic vinyl compound copolymer or the olefin-aromatic vinyl compound-aromatic polyene copolymer in the present coordination polymerization step, it is preferred to contact each of the above exemplified monomers, transition metal compound and co-catalyst. Any known method may be used for contacting order and contacting method. An example of the method of the above copolymerization is a method of polymerizing in a liquid monomer without a solvent or a method of polymerizing with a single solvent or a mixed solvent of a saturated aliphatic, an aromatic hydrocarbon or a halogenated hydrocarbon such as pentane, hexane, heptane, cyclohexane, benzene, toluene, ethylbenzene, xylene, chlorosubstituted benzene, chlorosubstituted toluene, methylene chloride, chloroform. Preferably, a mixed alkane solvent, cyclohexane, toluene or ethylbenzene is used.

The polymerization method may be either solution polymerization or slurry polymerization. If necessary, known methods such as batch polymerization, continuous polymerization, pre-polymerization, multistage polymerization may be applied. It is also possible to use a single or a plurality of connected tank type polymerization cans or a single, or a plurality of connected linear or loop pipe polymerization facilities. The pipe polymerization facility comprises various known mixers such as a dynamic mixer, a static mixer, a static mixer with a heat remover. The pipe polymerization facility comprises various known coolers such as a cooler equipped with a heat removal tube. A batch-type prepolymerization can may also be used. Further, a method such as gas phase polymerization may be applied.

The polymerization temperature is preferably 0 to 200° C. The polymerization temperature lower than 0° C., it is industrially disadvantageous. When the polymerization temperature exceeds 200° C., decomposition of the transition metal compound may occur. Further, from the industrial viewpoint, the polymerization temperature is preferably 0 to 160° C., particularly preferably 30° C. to 160° C. The pressure during polymerization is preferably 0.1 to 100 atm, more preferably 1 to 30 atm, particularly preferably, from the industrial viewpoint, 1 to 10 atm.

Surprisingly, the cross-copolymer of the present invention has good flowability (moldability), soft at room temperature, low crystallinity, low gel content, and high heat resistance. Specifically, a hardness is 50 or more and 85 or less, preferably 50 or more and 80 or less; a sum of a crystal fusion heat (AH) of the cross-copolymer observed at 0 to 150° C. is 25 J/g or less; MFR measured at 200° C. under a load of 98 N is 5 g/10 min or more and 40 g/10 min or less; and a gel content is less than 1% by mass, preferably less than 0.1% by mass. And, the heat resistance, that is, a ratio of the storage modulus at 100° C. to the storage modulus at 20° C. measured by DMA is 0.05 or more and 0.2 or less. That is, at high temperature, the decrease in the storage modulus is less and the high storage modulus is maintained. Further, the cross-copolymer of the present invention may have good mechanical properties, that is, a breaking point stress of 10 MPa or more in a tensile test and an elongation at break of 300% or more.

The method for producing the cross-copolymer of the present invention is characterized in that, in addition to the above-described producing method, in the coordination polymerization step, at least a single site coordination polymerization catalyst comprising a transition metal compound represented by the general formula (1) and a boron co-catalyst is used. It is further preferred that the boron co-catalyst is a borate co-catalyst. The heat resistance of the cross-copolymer of the present invention may be realized by the relatively broad molecular weight distribution of the macromonomer (olefin-aromatic vinyl compound-aromatic polyene copolymer), specifically Mw/Mn ratio of 3.5 or more and 6 or less. By using the present boron co-catalyst, a polymerization activity and copolymerization ability are high, and it is easy to obtain an olefin-aromatic vinyl compound-aromatic polyene copolymer having a molecular weight distribution satisfying the conditions of the present invention.

### 4. Anionic Polymerization Step (Crossing Step)

In the anionic polymerization step, polymerization is carried out using the anionic polymerization initiator in the presence of the ethylene-aromatic vinyl compound-aromatic polyene copolymer macromonomer and the aromatic vinyl compound monomer.

The solvent in the anionic polymerization is preferably a mixed alkane-based solvent, which does not cause disadvantages such as chain transfer during anionic polymerization, such as cyclohexane, benzene. When the polymerization temperature is 150° C. or less, other solvents such as toluene, ethylbenzene may also be used. As the polymerization method, any known method used for anionic polymerization may be applied.

In the present invention, the order of adding the aromatic vinyl compound monomer and the anionic polymerization initiator is arbitrary. That is, after adding the aromatic vinyl compound monomer to the polymerization solution and stirring, the anionic polymerization initiator may be added. Otherwise, the aromatic vinyl compound monomer may be added after adding of the anionic polymerization initiator. Since the cross-copolymer of the present invention is a copolymer obtained by a specific producing method defined by the present invention, its structure is arbitrary. The polymerization temperature is preferably −78 to 200° C. The polymerization temperature is lower than −78° C. is industrially disadvantageous. When the polymerization temperature exceeds 150° C., chain transfer and the like may occur, so that it is not preferable. Further, industrially preferably, the polymerization temperature is 0° C. to 200° C., particularly preferably 30 to 150° C. The pressure during polymerization is suitably 0.1 to 100 atm, preferably 1 to 30 atm, particularly preferably industrially particularly 1 to 10 atm.

For the anionic polymerization step of the present invention, a known anionic polymerization initiator may be used. Preferably, an alkyllithium compound, a lithium salt or a sodium salt of biphenyl, naphthalene, pyrene or the like, particularly preferably sec-butyllithium or n(normal)-butyllithium may be used. A multifunctional initiator, a dilithium compound, a trilithium compound may also be used. If necessary, a known anionic polymerization terminating coupling agent may be used. In the case where methylalumoxane is used as a co-catalyst of the polymerization catalyst in the coordination polymerization step, the amount of the initiator is used in an amount of not less than the equivalent amount of oxygen atoms contained therein, particularly preferably 2 equivalents or more. In the coordination polymerization step, when a boron compound is used as a co-catalyst of the polymerization catalyst, the amount thereof is sufficiently less than the oxygen atom equivalent amount in methylalumoxane, so that the amount of the initiator may be reduced.

### EXAMPLES

Hereinafter, the present invention will be further described with reference to examples, but the present invention is not limited thereto.

### 1. Analysis and Evaluation Method

Analysis of the copolymer obtained in the examples was carried out by the following means.

### (1H-Nmr Spectrum)

Determination of each unit content of olefin and aromatic vinyl compound in the copolymer was carried out by 1H-NMR, and α-500 manufactured by JEOL Ltd. was used as an instrument. The copolymer was dissolved in heavy 1,1,2,2-tetrachloroethane. When the copolymer was dissolved at room temperature, it was measured at room temperature. When the copolymer was not dissolved at room temperature, it was measured at 80 to 100° C. The areas of the peaks derived from each of the obtained units were compared by a known method to determine the content and composition of each unit. The mass ratio and the yield of the olefin-aromatic vinyl compound-aromatic polyene copolymer obtained in the coordination polymerization step included in the cross-copolymer finally obtained through the anionic polymerization step are determined by comparison of a composition of the olefin-aromatic vinyl compound-aromatic polyene copolymer and a composition of the cross-copolymer obtained through the anionic polymerization step. The mass % of the polystyrene chain obtained in the anionic polymerization step can also be determined in the same manner.

### (Gas Chromatography Analysis)

The content of divinylbenzene unit in the copolymer was determined according to the difference between the amount of unreacted divinylbenzene in the polymerization solution determined by gas chromatography analysis and the amount of divinylbenzene used for polymerization.

### (Molecular Weight Measurement)

The weight average molecular weight (Mw) and number average molecular weight (Mn) in terms of standard polystyrene were determined by GPC (gel permeation chromatography). The measurement was carried out under the following conditions.

Column: Two of TSK-GEL Multipore HXL-M φ 7.8×300 mm (manufactured by Tosoh Corporation) were connected in series and used.
Column temperature: 40° C.

### Detector: RI

### Solvent: THF

Sending solution flow rate: 1.0 ml/min.
Sample concentration: 0.1 mass/volume %
Sample injection amount: 100 μL

When the polymer is insoluble in THF solvent at room temperature, the weight average molecular weight in terms of standard polystyrene was determined by high-temperature GPC (gel permeation chromatography). The molecular weight is measured using HLC-8121 GPC/HT manufactured by Tosoh Corporation with a column of TSKgel GMHHR-H (20) HT, three 7.8×300 mm φ7.8×300 mm and orthodichlorobenzene as a solvent at 140° C.

### Detector: RI

Sample concentration: 0.1 mass/volume %
Sample injection amount: 100 μL
Sending solution flow rate: 1.0 ml/min.

### (DSC Measurement)

DSC measurement was carried out using DSC 6200 manufactured by Seiko Instruments Inc. under a nitrogen stream. That is, 10 mg of resin was used, 10 mg of alumina was used as a reference, the temperature was raised from room temperature to 240° C. at a heating rate of 10° C./min under a nitrogen atmosphere using an aluminum pan and then cooled to −120° C. at 20° C./min. Thereafter, DSC measurement was carried out while raising the temperature to 240° C. at a heating rate of 10° C./min, and the melting point, the heat of crystal fusion, and the glass transition point were determined.

### (Preparation of Sample Sheet)

Sheets of various thickness (0.3, 1.0, 2.0 mm) formed by a hot press method (temperature 250° C., 5 minutes, pressure of 50 kg/cm²) were prepared as samples for physical property evaluation.

### (Measurement of Viscoelasticity)

A sample for measurement (8 mm×50 mm) was cut out from a film having a thickness of about 0.3 mm obtained by the hot press method and measured with a dynamic viscoelasticity measuring device (RSA-III manufactured by Rheometrics Co.) at a frequency of 1 Hz and a temperature range of −50° C. to +250° C. to determine the storage modulus, the loss modulus, the tangent δ value, and the residual elongation (δL) of the sample.

Other measurement parameters related to measurement are as follows.

Measurement frequency: 1 Hz
Heating rate: 4° C./min
Sample measurement length: 10 mm

### Test Type=Dynamic Temperature Ramp (DTempRamp)

### Initial Static Force 5.0 g

### Auto Tension Sensitivity 1.0 g

Max Auto Tension Rate 0.033 mm/s

### Max Applied Strain 1.5%

### Min Allowed Force 1.0 g

In the present specification, the storage modulus (E′) and the loss modulus (E″) are expressed as, for example, 1.35E+07 Pa or 3.10E+08 Pa. Here, 1.35E+07 Pa is 1.35×10⁷ Pa, and 3.10E+08 Pa is 3.10×10⁸ Pa.

### (Tensile Test)

In accordance with JIS K-6251, a sheet having a thickness of 1.0 mm was cut into No. 2 No. 1/2 type test piece shape to measure at a tensile speed of 500 mm/min using Shimadzu AGS-100D type tensile testing machine.

### (A Hardness)

A durometer hardness of type A was determined according to the durometer hardness test method of JIS K-7215 plastic by overlapping 2 mm thick sheets. This hardness is an instantaneous value.

### (MFR)

Under the conditions of 200° C. and a load of 98 N in accordance with JIS K 7210.

### (Gel Content)

According to ASTM D-2765-84, the gel content of the cross-copolymer was measured. That is, 1.0 g of precisely weighed polymer (molded article having a diameter of about 1 mm and a length of about 3 mm) was wrapped in a 100 mesh stainless steel mesh bag and precisely weighed. After extracting it in boiling xylene for about 5 hours, the net bag was recovered and dried at 90° C. in vacuo over 10 hours. After cooling sufficiently, the net bag was precisely weighed, and the amount of polymer gel was calculated by the following formula.

Gel Amount=mass of polymer remaining in net bag/first polymer mass×100

### 2. Examples and Comparative Examples

### Example 1

21.2 kg of methylcyclohexane (manufactured by Maruzen Petrochemical Co., Ltd.) as a solvent, 3.2 kg of styrene monomer and 91 mmol of divinylbenzene were charged, and heatstirred at an internal temperature of 70° C. in 50 L polymerization can with a heating and cooling jacket. About 100 L of dry nitrogen gas was bubbled to purge moisture inside of the system and the polymerization solution. Next, the internal temperature was raised to about 85° C., 50 mmol of triisobutylaluminum was added, and ethylene was immediately introduced. After stabilizing at a pressure of 0.40 MPa (0.30 MPaG), a catalyst solution of 30 ml of toluene solution containing 1 mmol of triisobutylaluminum from the catalyst tank on an autoclave, 100 μmol of rac-isopropylidenebis (4,5-benzoindenyl) zirconium dichloride as a catalyst, 110 μmol of triphenylcarbenium tetrakis (pentafluorophenyl) borate as a B type co-catalyst is added into the autoclave by nitrogen pressure to start the coordination polymerization step. The polymerization was carried out while keeping the internal temperature at 95° C. and the pressure at 0.40 MPa. Ethylene supply was stopped at a predetermined ethylene cumulative flow rate, and the autoclave was rapidly cooled to 70° C. while releasing the pressure. A small amount (several tens of ml) of the polymerization solution was sampled and mixed in methanol to precipitate a polymer, thereby obtaining a polymer sample for the coordination polymerization step. The polymer yield, composition and molecular weight in the coordination polymerization step were determined based on this sampling solution. 60 mmol of n-butyllithium was added to the polymerization tank, and a cross-copolymer was synthesized by performing an anionic polymerization step while maintaining the temperature at 70° C. The obtained polymerization solution was poured little by little into a vigorously stirred large amount of methanol solution to recover the cross-copolymer. After air-drying the cross copolymer at room temperature for 1 day and night, the cross copolymer was dried at 80° C. in a vacuum until no mass change was observed.

### Examples 2 to 3

Polymerizations were carried out under the polymerization conditions shown in Table 1 by the same procedure as in Example 1.

### Comparative Examples 1 to 3

By the same procedure as in Example 1, under the polymerization conditions shown in Table 1, except that MMAO (modified MAO, manufactured by Tosoh-Finechem Co., Ltd.) was used instead of triphenylcarbeniumtetrakis (pentafluorophenyl) borate as a co-catalyst to perform the polymerization.

TABLE 1

| | | | | | | | | | | Anionic | |
|---|---|---|---|---|---|---|---|---|---|---|---|
| | Coordination Polymerization Step | | | | | | | | | Polymerization | |
| | | MAO | B type | | | | | | | Step | |
| | Catalyst | co-catalyst | co-catalyst | Styrene | Solvent | Temp. | Ethylene | DVB | Ethylene | BuLi | Yield |
| | μ mol | mmol | μ mol | kg | kg | ° C. | MPa | mmol | Consumption L | mmol | kg |
| Example 1 | 100 | — | 110 | 3.2 | MCH: 21.2 | 95 | 0.40 | 91 | 1300 | 60 | 4.9 |
| Example 2 | 120 | — | 130 | 3.2 | CH: 21.3 | 85 | 0.40 | 91 | 1000 | 60 | 4.4 |
| Example 3 | 120 | — | 130 | 2.3 | CH: 21.3 | 95 | 0.49 | 87 | 1600 | 60 | 4.3 |
| Comparative | 100 | 80 | — | 3.2 | CH: 21.3 | 90 | 0.40 | 91 | 1200 | 240 | 4.7 |
| Example 1 | | | | | | | | | | | |
| Comparative | 100 | 80 | — | 2.8 | CH: 21.6 | 85 | 0.42 | 67 | 1400 | 220 | 4.5 |
| Example 2 | | | | | | | | | | | |
| Comparative | 100 | 60 | — | 2.8 | CH: 21.6 | 75 | 0.42 | 67 | 1300 | 220 | 4.4 |
| Example 3 | | | | | | | | | | | |

The analysis results of the ethylene-styrene-divinylbenzene copolymer obtained in the coordination polymerization step of each Example and Comparative Example, and the cross-copolymer obtained through the anionic polymerization step are shown in Table 2, and the evaluations of the cross-copolymer are shown in Tables 3 and 4. The vinyl group hydrogen (proton) peak intensity (area) of the divinylbenzene unit of the cross-copolymer obtained in each of Examples 1 to 3 was less than 20% as compared with the same peak intensity (area) of the divinylbenzene unit of the ethylene-styrene-divinylbenzene copolymer obtained in the coordination polymerization step. Actually, the hydrogen (proton) peak of the vinyl group of the divinylbenzene unit was substantially disappeared in the cross-copolymer after the anionic polymerization.

TABLE 2

| | Coordination Polymerization Step | | | | Anionic | | | Proportion (mass %) of |
|---|---|---|---|---|---|---|---|---|
| | Styrene | DVB | | | Polymerization Step | | | the copolymer obrained |
| | Content | Content | | | PS | PS | | Coordination Polymerization |
| | mol % | mol % | Mw/10⁴ | Mw/Mn | mass % | Mw/10⁴ | PS Mw/Mn | Step |
| Example 1 | 23.8 | 0.065 | 15.8 | 3.9 | 26 | 4.0 | 1.2 | 74 |
| Example 2 | 26.3 | 0.068 | 17.8 | 4.1 | 34 | 3.6 | 1.2 | 66 |
| Example 3 | 16.0 | 0.060 | 10.3 | 3.8 | 20 | 3.5 | 1.1 | 80 |
| Comparative | 25.2 | 0.060 | 14.5 | 2.7 | 26 | 2.4 | 1.2 | 74 |
| Example 1 | | | | | | | | |
| Comparative | 22.0 | 0.060 | 19.5 | 2.8 | 22 | 2.5 | 1.3 | 78 |
| Example 2 | | | | | | | | |
| Comparative | 23.2 | 0.060 | 23.0 | 3.0 | 21 | 2.7 | 1.2 | 79 |
| Example 3 | | | | | | | | |

TABLE 3

| | DSC | | Viscoelasticity | | |
|---|---|---|---|---|---|
| | Tm | Δ H | E′ (Pa) | | E′ ratio |
| Table 3 | ° C. | J/g | 20° C. | 100° C. | 100° C./20° C. |
| Example1 | — # | — * | 1.35E+07 | 1.08E+06 | 0.080 |
| Example2 | — # | — * | 6.25E+07 | 6.00E+06 | 0.096 |
| Example3 | — # | — * | 2.00E+07 | 1.15E+06 | 0.058 |
| Comparative | — # | — * | 1.00E+07 | 3.50E+05 | 0.035 |
| Example1 | | | | | |
| Comparative | — # | — * | 1.50E+07 | 6.30E+05 | 0.042 |
| Example2 | | | | | |
| Comparative | — # | — * | 1.40E+07 | 1.00E+06 | 0.071 |
| Example3 | | | | | |
| Comparative | — # | — * | 3.10E+08 | 4.50E+06 | 0.015 |
| Example4 | | | | | |
| Comparative | 65 | 60 | 2.00E+07 | 5.00E+04 | 0.003 |
| Example5 | | | | | |

— # No peak having the heat of crystal fusion of 10 J/g or more was observed.
— * Sum of the heat of crystal fusion was 10 J/g or less.

TABLE 4

| | | Breaking | | Initial | | |
|---|---|---|---|---|---|---|
| | | Point | Elongation | Tensile | MFR | Gel |
| | A | Stress | at Break | Modulus | 200° C. 98 N | Content |
| | Hardness | MPa | % | MPa | g/10 min | mass % |
| Example 1 | 64 | 14 | 740 | 6.0 | 23 | <0.1 |
| Example 2 | 74 | 17 | 650 | 10.0 | 7 | <0.1 |
| Example 3 | 75 | 16 | 810 | 11.0 | 9 | <0.1 |
| Comparative Example 1 | 60 | 12 | 700 | 5.8 | 30 | <0.1 |
| Comparative Example 2 | 65 | 21 | 970 | 5.0 | 9 | <0.1 |
| Comparative Example 3 | 63 | 25 | 870 | 4.7 | 2 | <0.1 |
| Comparative Example 4 | 83 | 18 | 650 | 23.0 | 5 | |
| Comparative Example 5 | 72 | 20 | 750 | 7.7 | 9 | |

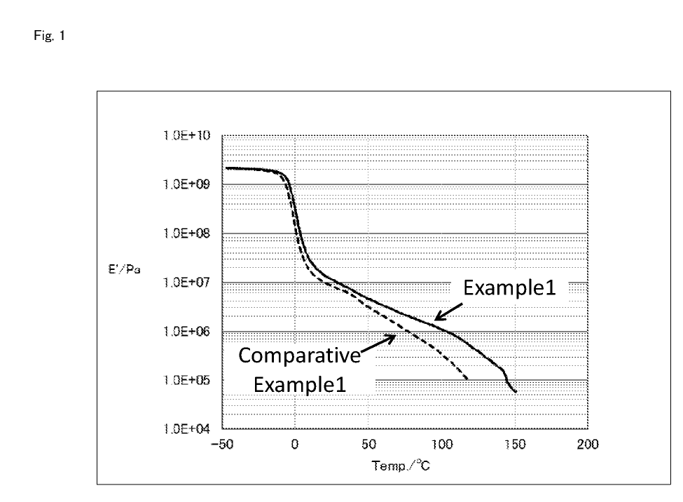

All of the cross-copolymers obtained in Examples 1 to 3 have softness (A hardness), low crystallinity, flowability (moldability), low gel content, high heat resistance (a ratio of a storage modulus at 100° C. to a storage modulus at 20° C.). Further, any cross-copolymer is obtained under manufacturing conditions satisfying the conditions of the producing method of the present invention. On the other hand, the copolymers of Comparative Examples 1 to 3 were obtained by a producing method using MAO (alumoxane) as a co-catalyst, and did not satisfy the condition of the molecular weight distribution (Mw/Mn) of the ethylene-styrene-divinylbenzene copolymer macromonomer. The cross-copolymer obtained in Comparative Examples 1 and 2 has softness (A hardness), low crystallinity, fluidity (moldability), low gel content, but low heat resistance. The cross-copolymer obtained in Comparative Example 3 has high heat resistance, but low MFR value and low moldability. FIG. 1 shows the relationship between the temperature and the storage modulus obtained by the viscoelasticity measurement of the cross-copolymer obtained in Example 1 and Comparative Example 1.

Further, Comparative Examples 4 and 5 respectively shows physical properties and heat resistances of commercially available SEPS (A hardness 83) and ethylene-octene copolymer (A hardness 72). These resins also have low heat resistance.

### INDUSTRIAL APPLICABILITY

The cross-copolymer of the present invention has good moldability and satisfies softness and heat resistance, so that it is useful as a thermoplastic elastomer.

1. A method for producing a cross-copolymer comprising a coordination polymerization step and an anionic polymerization step, wherein
the coordination polymerization step is followed by the anionic polymerization step,
in the coordination polymerization step, an ethylene-aromatic vinyl compound-aromatic polyene copolymer which is a macromonomer is synthesized by copolymerizing an ethylene monomer, an aromatic vinyl compound monomer and an aromatic polyene with a single site coordination polymerization catalyst,
in the anionic polymerization step, a polymerization using an anionic polymerization initiator in the presence of the macromonomer and an aromatic vinyl compound monomer is performed, and
the cross-copolymer satisfies all the following features (1) to (3):
(1) in the ethylene-aromatic vinyl compound-aromatic polyene copolymer macromonomer, the aromatic vinyl compound unit content is 15 mol % or more and 30 mol % or less, the aromatic polyene unit content is 0.01 mol % or more and 0.2 mol % or less, and the rest is the ethylene unit content;
(2) a weight average molecular weight (Mw) of the ethylene-aromatic vinyl compound-aromatic polyene copolymer macromonomer is 100000 or more and 250000 or less and a molecular weight distribution (Mw/Mn) is 3.5 or more and 6 or less;
(3) a mass ratio of the ethylene-aromatic vinyl compound-aromatic polyene copolymer macromonomer component in the cross-copolymer obtained through the anionic polymerization step is 60% by mass or more and 95% by mass or less.

2. The method of claim 1, wherein in the coordination polymerization step, the single site coordination polymerization catalyst contains a transition metal compound represented by a general formula (1) or (6), 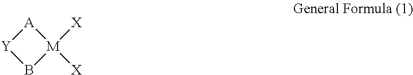
wherein in the general formula (1),
A and B may be the same or different from each other, and each of A and B is a group selected from an unsubstituted or substituted benzoindenyl group, an unsubstituted or substituted cyclopentadienyl group, an unsubstituted or substituted indenyl group, or an unsubstituted or substituted fluorenyl group, wherein
the substituted benzoindenyl group, the substituted cyclopentadienyl group, the substituted indenyl group, and the substituted fluorenyl group are respectively a substituted benzoindenyl group, a substituted cyclopentadienyl group, a substituted indenyl group, and a substituted fluorenyl group in which one or more of substitutable hydrogens are substituted with an alkyl group having 1 to 20 carbon atoms, an aryl group having 6 to 10 carbon atoms, an alkylaryl group having 7 to 20 carbon atoms, a halogen atom, OSiR₃ group, SiR₃ group or PR₂ group (R represents a hydrocarbon group having 1 to 10 carbon atoms);
Y has a bond with A and B, and Y may have, as a substituent, hydrogen, a methylene group, a silylene group, an ethylene group, a germylene group or a boron group, each of the methylene group, the silylene group, the ethylene group, the germylene group, and the boron group may have a hydrocarbon group having 1 to 15 carbon atoms (and may further have 1 to 3 of a nitrogen atom, an oxygen atom, a sulfur atom, a phosphorus atom, or a silicon atom), the substituents of Y may be same or different from each other, Y may have a cyclic structure;
X is hydrogen, a hydroxyl group, a halogen, a hydrocarbon group having 1 to 20 carbon atoms, an alkoxy group having 1 to 20 carbon atoms, a silyl group having a hydrocarbon substituent having 1 to 4 carbon atoms, or an amide group having a hydrocarbon substituent having 1 to 20 carbon atoms, and two of X may have a bond therebetween; and
M is zirconium, hafnium, or titanium, 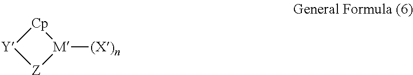
wherein in the general formula (6),
Cp is a group selected from an unsubstituted or substituted cyclopentaphenanthryl group, an unsubstituted or substituted benzoindenyl group, an unsubstituted or substituted cyclopentadienyl group, an unsubstituted or substituted indenyl group, or an unsubstituted or substituted fluorenyl group, wherein
the substituted cyclopentaphenanthryl group, the substituted benzoindenyl group, the substituted cyclopentadienyl group, the substituted indenyl group, and the substituted fluorenyl group are respectively a substituted benzoindenyl group, a substituted cyclopentadienyl group, a substituted indenyl group, and a substituted fluorenyl group in which one or more of substitutable hydrogens are substituted with an alkyl group having 1 to 20 carbon atoms, an aryl group having 6 to 10 carbon atoms, an alkylaryl group having 7 to 20 carbon atoms, a halogen atom, a OSiR₃ group, a SiR₃ group or a PR₂ group (R represents a hydrocarbon group having 1 to 10 carbon atoms);
Y′ has a bond with Cp and Z, and Y′ may have, as a substituent, hydrogen, or a methylene group, a silylene group, an ethylene group, a germylene group or a boron group, each of the methylene group, the silylene group, the ethylene group, the germylene group, and the boron group may have a hydrocarbon group having 1 to 15 carbon atoms, the substituents of Y′ may be same or different from each other, Y′ may have a cyclic structure;
Z has a nitrogen atom, an oxygen atom or a sulfur atom, Z is a ligand coordinating to M′ by the nitrogen atom, the oxygen atom or the sulfur atom, Z has a bond with Y′, and Z further has hydrogen or a group having a sub stituent having 1 to 15 carbon atoms;
M′ is zirconium, hafnium, or titanium;
X′ is hydrogen, halogen, an alkyl group having 1 to 15 carbon atoms, an aryl group having 6 to 10 carbon atoms, an alkylaryl group having 8 to 12 carbon atoms, a silyl group having a hydrocarbon substituent having 1 to 4 carbon atoms, an alkoxy group having 1 to 10 carbon atoms, or a dialkylamide group having an alkyl substituent having 1 to 6 carbon atoms; and
n is an integer of 1 or 2.

3. The method of claim 1, wherein in the coordination polymerization step, the single site coordination polymerization catalyst containing a transition metal compound represented by the general formula (1) and a boron co-catalyst is used.

4. The method of claim 3, wherein the boron co-catalyst is a borate co-catalyst.

5. A cross-copolymer obtained by the method of claim 1, wherein the cross-copolymer satisfies all the following features (A) to (E):
(A) a hardness is 50 or more and 85 or less;
(B) a sum of a crystal fusion heat (AH) of the cross-copolymer observed at 0 to 150° C. is 25 J/g or less;
(C) MFR measured at 200° C. under a load of 98 N is 5 g/10 min or more and 40 g/10 min or less;
(D) a gel content of less than 1% by mass;
(E) a ratio of a storage modulus at 100° C. to a storage modulus at 20° C. measured with DMA is 0.05 or more and 0.2 or less.

6. A cross-copolymer comprising an ethylene-aromatic vinyl compound-aromatic polyene copolymer chain and an aromatic vinyl compound polymer chain, wherein
the ethylene-aromatic vinyl compound-aromatic polyene copolymer chain and the aromatic vinyl compound polymer chain bonded via the aromatic polyene unit, and
the cross-copolymer satisfies all the following features (1) to (3):
(1) in the ethylene-aromatic vinyl compound-aromatic polyene copolymer macromonomer, the aromatic vinyl compound unit content is 15 mol % or more and 30 mol % or less, the aromatic polyene unit content is 0.01 mol % or more and 0.2 mol % or less, and the rest is the ethylene unit content;
(2) a weight average molecular weight (Mw) of the ethylene-aromatic vinyl compound-aromatic polyene copolymer macromonomer is 100000 or more and 250000 or less and a molecular weight distribution (Mw/Mn) is 3.5 or more and 6 or less;
(3) a mass ratio of the ethylene-aromatic vinyl compound-aromatic polyene copolymer macromonomer component in the cross-copolymer obtained through the anionic polymerization step is 60% by mass or more and 95% by mass or less.

7. The cross-copolymer of claim 6, wherein the cross-copolymer is a graft-through copolymer of an ethylene-aromatic vinyl compound-aromatic polyene copolymer chain and an aromatic vinyl compound polymer chain.

8. The cross-copolymer of claim 6, wherein the cross-copolymer further satisfies all the following features (A) to (E):
(A) a hardness is 50 or more and 85 or less;
(B) a sum of a crystal fusion heat (ΔH) of the cross-copolymer observed at 0 to 150° C. is 25 J/g or less;
(C) MFR measured at 200° C. under a load of 98 N is 5 g/10 min or more and 40 g/10 min or less;
(D) a gel content of less than 1% by mass;
(E) a ratio of a storage modulus at 100° C. to a storage modulus at 20° C. measured with DMA is 0.05 or more and 0.2 or less.
